(19) United States
(12) Patent Application Publication
(10) Pub. No.: US 2026/0015540 A1
(43) Pub. Date: Jan. 15, 2026

(54) EMULSIFIER COMPOSITIONS, AND RELATED METHODS AND WELLBORE FLUIDS INCLUDING THE EMULSIFIER COMPOSITIONS

(71) Applicant: Schlumberger Technology Corporation, Sugar Land, TX (US)

(72) Inventors: Lynn Foster, Pearland, TX (US); Dimitri Khramov, Katy, TX (US); Evgeny Barmatov, Cambridge (GB)

(21) Appl. No.: 18/771,513

(22) Filed: Jul. 12, 2024

(51) Int. Cl. C09K 8/60

(52) U.S. Cl. CPC C09K 8/602

(57) ABSTRACT

An emulsifier composition for a for a wellbore fluid includes an emulsifier including an amidoamine, and a pour point depressant including one or both of a C₅ to C₁₃ or a C₅ to C₁₂ alkoxylated alcohol including two or fewer than two alkylene oxide groups. The emulsifier composition exhibits a pour point lower than about 0° C. Related methods of forming a borehole extending through an earth formation, and related wellbore fluids including the emulsifier composition are also disclosed.

### CROSS REFERENCE TO RELATED APPLICATIONS

N/A.

### BACKGROUND

Wellbore drilling operations include drilling a bore in a formation to access reservoirs of hydrocarbons and other subsurface resources. During drilling of a wellbore, various fluids may be circulated into the wellbore through a drill pipe and drill bit, and may subsequently flow upward through the wellbore to the surface. For example, a drilling fluid (e.g., an aqueous-based fluid or an oil-based fluid) may be pumped down the inside of the drill pipe, through the drill bit, and into the wellbore. The drilling fluid returns to the surface through the annulus. The drilling fluid may lubricate and cool the drill bit, facilitate transport of formation cuttings to the surface, prevent formation blowouts by maintaining a hydrostatic pressure greater than the formation pressure, maintain well stability, and/or reduce fluid loss to the formation.

Drilling fluids may be water-based (aqueous-based), or may be non-aqueous, such as oil-based or synthetic-based. In non-aqueous drilling fluids, water is the discontinuous (dispersed) phase and oil (or a synthetic material) is the continuous phase. Non-aqueous drilling fluids may be more compatible with water-sensitive formations, such as water-sensitive clays, than aqueous drilling fluids. In addition, non-aqueous drilling fluids may not substantially cause shale instability to the formation as may be more common with aqueous drilling fluids.

Non-aqueous drilling fluids may be stabilized with an emulsifier. Emulsifiers may be used to lower the interfacial tension between an oil phase and an aqueous phase, facilitating the formation of a stable invert emulsion. One difficulty associated with the provision of an emulsifier in a drilling fluid is mixing the emulsifier with the drilling fluid. For example, in their pure form, emulsifiers are often tacky solids and/or soft waxes that exhibit poor rheological properties, making it difficult to mix the emulsifier with the drilling fluid at a well site.

### BRIEF SUMMARY

In some embodiments, an emulsifier composition for a wellbore fluid includes an emulsifier including an amidoamine, and a pour point depressant including one or both of a C₅ to C₁₃ or a C₅ to C₁₂ alkoxylated alcohol including two or fewer alkylene oxide groups. The emulsifier composition exhibits a viscosity less than about 1,500 cP at about 4° C.

In some embodiments, a method of forming a borehole extending through an earth formation includes mixing an emulsifier composition with a drilling fluid. The emulsifier composition exhibits a pour point lower than about 0° C. and includes an emulsifier including an amidoamine, and a pour point depressant including an alcohol having fewer than thirteen carbon atoms and less than two ethylene oxide groups. The method further includes forming a borehole in the earth formation while pumping the drilling fluid including the emulsifier composition into the earth formation.

In some embodiments, a wellbore fluid includes an oleaginous base fluid, and an emulsifier composition including an emulsifier including an amidoamine comprising a reaction product of a bis-amide and one or more of maleic acid, maleic anhydride, fumaric acid, succinic acid, succinic anhydride, oxalic acid, malonic acid, adipic acid, azelaic acid, muconic acid, citraconic acid, itaconic acid, tartaric acid, or glutaric acid, a pour point depressant including a C₅ to C₁₃ alcohol including fewer than one ethylene oxide group, the emulsifier composition exhibiting a viscosity less than about 1,500 cP at about 4.0° C., and at least one of a wetting agent and a rheology modifier.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a representation of a drilling system for drilling an earth formation to form a wellbore, according to at least one embodiment of the present disclosure;

FIG. 2 is a simplified reaction scheme illustrating a reaction scheme for forming an amide by reacting a polyalkylamine with a fatty acid, according to at least one embodiment of the present disclosure;

FIG. 3 is a chemical structure illustrating a reaction product of an amide and a dicarboxylic acid, according to at least one embodiment of the present disclosure;

FIG. 4 is a chemical structure illustrating a reaction product of a bis-amide and maleic acid, according to at least one embodiment of the present disclosure;

FIG. 5 is a chemical structure that may be used as a rheology modifier, according to at least one embodiment of the disclosure;

FIG. 6 is a chemical structure that may be used as a rheology modifier, according to at least one embodiment of the disclosure;

FIG. 7 is a simplified flow diagram illustrating a method of drilling a wellbore using a drilling fluid including an emulsifier composition, according to at least one embodiment of the disclosure; and

FIG. 8 is a graph showing the fluid loss of drilling fluids including emulsifier compositions including different pour point depressants.

### DETAILED DESCRIPTION

As used herein, a “hydrocarbyl” group means and includes a C₁ to C₁₀₀ hydrocarbon (e.g., a radical) and may be linear, branched, and/or cyclic (e.g., include one or more cyclic groups, which may be aromatic or non-aromatic). The C₁ to C₁₀₀ hydrocarbyl group may be saturated or unsaturated (e.g., include one or more carbon-carbon double bonds (e.g., include one or more alkenyl groups)). Non-limiting examples of hydrocarbyl groups include methyl, ethyl, n-propyl, isopropyl, n-butyl, isobutyl, sec-butyl, tert-butyl, pentyl, iso-amyl, hexyl, heptyl, octyl, cyclopropyl, cyclobutyl, cyclopentyl, cyclohexyl, cyclooctyl, and the like, including substituted analogues. For example, at least one hydrogen atom may be substituted with at least one heteroatom or a heteroatom-containing group, such as a halogen (e.g., F, Cl, Br, I), or at least one functional group, such as NR′₂, OR′, SeR′, TeR′, PR′₂, ASR′₂, SbR′₂, SR′, BR′₂, SiR′₃, GER′₃, SnR′₃, PbR′₃, and the like, wherein R′ is hydrogen, alkyl, hydroxyalkyl, carboxyalkyl, or another group, or where at least one heteroatom has been inserted within a hydrocarbyl ring.

As used herein, the term “bis-amide” refers to a compound having two identical amide groups. A polyamide may include a compound having two or more amide groups, which may or may not be identical.

As used herein, the term “polyalkylamine” refers to a compound having alternating amine and alkyl groups. Polyalkylamines may be linear or branched.

As used herein, the term “barrel” is a volume equivalent to 42 gallons. Quantities of various materials (e.g., additives) are often quantified in barrels in the oil and gas industry.

This disclosure generally relates to devices, systems, and methods of manufacturing and using wellbore (e.g., drilling) fluid additives for downhole applications, such as emulsifier compositions (also referred to herein as “emulsifier packages”) for use in a wellbore fluid. The emulsifier composition may be used in a wellbore fluid, such as in drilling fluids, workover fluids, spacer fluids (e.g., a fluid introduced into the wellbore after a drilling fluid and prior to a cement composition to flush residual drilling fluid from the annulus), stimulation fluids, or other wellbore fluids. Drilling fluids may include drill-in fluids (also referred to as “reservoir drill-in fluids” (RDF)). The emulsifier composition may be used during drilling of a wellbore or borehole for producing hydrocarbons, for storing hydrocarbons, or for forming other types of wellbores. The emulsifier composition is not limited to the particular type of borehole or wellbore being drilled.

The emulsifier composition may be provided as a component of a wellbore fluid. In some embodiments, the emulsifier composition is used in an oil-based or synthetic-based wellbore fluid (e.g., an oil-based drilling fluid or a synthetic-based drilling fluid, which may also be referred to as a non-aqueous drilling fluid or an invert emulsion drilling fluid).

The emulsifier composition may include an emulsifier (an amidoamine emulsifier), a pour point depressant (PPD), and optionally, one or both of a wetting agent, and a rheology modifier. The emulsifier may include an amidoamine including a reaction product of an amide and one or more of dicarboxylic acids, such as one or more of maleic acid, maleic anhydride, fumaric acid, succinic acid, succinic anhydride, oxalic acid, malonic acid, adipic acid, azelaic acid, muconic acid, citraconic acid, itaconic acid, tartaric acid, or glutaric acid. The amide may include the reaction product of a polyalkylamine and one or more fatty acids. In some embodiments, the amide includes a bis-amide.

The pour point depressant may include an alcohol and may, in some embodiments, be substantially free of glycols and glycol-based pour point depressants, such as triethylene glycol monobutyl ether (BTG) (also referred to as butylenetriglycol, butyltriglycol, butoxytriglycol) (C₁₀H₂₂O₄; C₄H₉(OCH₂CH₂)₃OH), butylene diglycol (BDG) (also referred to as butyl diglycol butyl, butyl dioxitol, diethylene glycol monobutyl ether, butoxydiglycol, butyldiglycol, di(ethylene glycol) butyl ether) (C₈H₁₈O₃; C₄H₉(OCH₂CH₂)₂OH), and di(propylene glycol) methyl ether. In some embodiments, the pour point depressant is constituted of alcohols having fewer than two ether groups, such as two ethylene oxide groups and/or propylene oxide groups. In some embodiments, the pour point depressant includes C₅ to C₁₃ alcohols having two or fewer alkylene oxide groups (e.g., no more than two ethylene oxide groups, two propylene oxide groups, or a combination of a propylene oxide group and an ethylene oxide group). In some embodiments, the alcohol exhibits a polarity that is less than a polarity of glycol-based pour point depressants, such as BTG and BDG. In some embodiments, the alcohol includes a non-polar alcohol. In some embodiments, the alcohol is not ethoxylated or propoxylated and/or the pour point depressant includes at least some non-ethoxylated alcohol and some ethoxylated alcohol. The alcohol may include C₅ to C₁₃ alcohols. The pour point depressant may not include (e.g., may be free or substantially free of) BTG or BDG. Selecting the pour point depressant to include a C₅ to C₁₃ alcohol having two or fewer alkylene oxide (e.g., ethylene oxide, propylene oxide) groups may facilitate forming the pour point depressant to exhibit desired properties, such as a flash point that is higher than a predetermined flashpoint and a viscosity that is less than a predetermined viscosity. For example, BDG includes two ethylene oxide groups and a C₄ chain bonded to one of the ethylene oxide groups. Since BDG includes a C₄ chain bonded to the ethylene oxide group, BDG exhibits a lower flash point than C₅ to C₁₃ alcohols, such as a C₅ ethoxylated alcohol including two ethylene oxide groups and the pour point depressant may be substantially free of BDG. As another example, BTG includes three ethylene oxide groups and a C₄ chain bonded to one of the ethylene oxide groups. BTG exhibits a viscosity that is higher than a threshold viscosity. Since the pour point depressants described herein include two or fewer ethylene oxide or propylene oxide groups, the pour point depressants do not exhibit a viscosity that is too high. Accordingly, the pour point depressant may exhibit a desired flash point and a desired viscosity.

The pour point depressant including the alcohol may constitute a lower weight percent of the emulsifier composition than emulsifier compositions including glycol-based pour point depressants. For example, the pour point depressant may constitute less than about 20.0 weight percent of the emulsifier composition, such as less than about 15.0 weight percent, or less than about 10.0 weight percent of the emulsifier composition. The emulsifier composition may exhibit a pour point as low as −25° C. and a Brookfield viscosity less than about 1,500 cP at about 4.4° C. (about 40.0° F.). Since the pour point depressant constitutes a lower weight percent of the emulsifier composition, the emulsifier composition may include a higher weight percent of the active component (e.g., the emulsifier) compared to emulsifier compositions including glycol-based pour point depressants.

The wetting agent, if present in the emulsifier composition, may include one or more fatty acids, such as one or more unsaturated fatty acids. For example, the wetting agent may include unsaturated C₁₈ fatty acids, such as oleic acid, linoleic acid, and/or linolenic acid. The rheology modifier, if present in the emulsifier composition, may include one or more alcohol ethoxylates, amine ethoxylates, ethylene oxide/propylene oxide copolymers, dimer acids, or trimer acids.

The alcohol pour point depressants described herein may facilitate lowering the pour point of the emulsifier composition with a relatively lower amount of the pour point depressant than conventional emulsifier packages including glycol-based pour point depressants and/or pour point depressants including two or fewer ether groups (e.g., two or fewer ethylene oxide groups, two or fewer propylene oxide groups, or one or zero ethylene oxide groups and one or zero propylene oxide groups). Accordingly, for the same weight percent of the pour point depressant, the emulsifier composition may exhibit a relatively lower pour point than an emulsifier composition including a glycol-based pour point depressant. In addition, for the same pour point, the emulsifier composition may include a relatively lower amount of the alcohol-based pour point depressant described herein compared to glycol-based pour point depressants. In some such embodiments, the emulsifier compositions described herein may exhibit a desired pour point and viscosity with less pour point depressant, facilitating an emulsifier composition including a higher weight percent of active components (e.g., a higher weight percent of the emulsifier) compared to emulsifier compositions including glycol-based pour point depressants and/or base oils for reducing the pour point and viscosity to a desirable level. In addition, because the emulsifier composition does not include glycol-based pour point depressants, the wellbore fluids that include the emulsifier composition may not include the glycol-based pour point depressants, which often negatively affect emulsion stability due to the high hydrophilic-lipophilic balance (HLB) value of the glycol-based pour point depressants. In addition, glycol-based pour point depressants are polar and, therefore, have a higher solubility in the aqueous phase than in the oleaginous phase, which negatively affects the stability of the emulsion in the invert emulsion. Further, the pour point depressants described herein are stable at HTHP conditions that may be experienced in the wellbore and/or earth formation and do not degrade. By way of contrast, some glycol-based pour point depressants (such as BTG, BDG, and di(propylene glycol) methyl ether) may weaken emulsion stability in drilling fluids due to their high hydrophilic-lipophilic balance and reduced ability to change solubility from the aqueous phase to the oleaginous phase with changing temperature. Accordingly, wellbore fluids including the emulsifier compositions described herein may exhibit improved properties compared to wellbore fluids that include glycol-based pour point depressants.

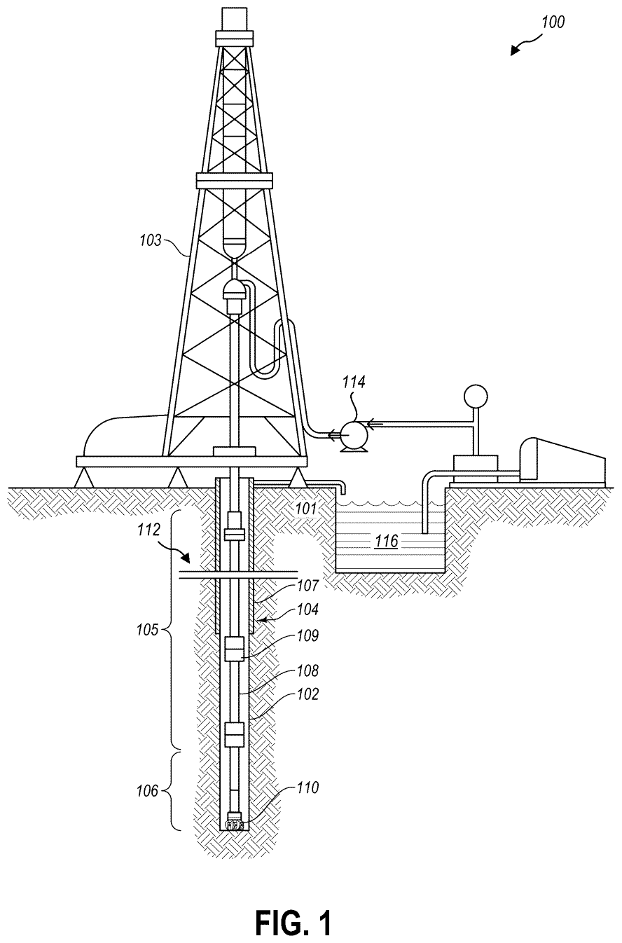

FIG. 1 shows one example of a drilling system 100 for drilling an earth formation 101 to form a borehole 102 defining a wellbore 112. The drilling system 100 includes a drill rig 103 used to turn a drilling tool assembly 104 which extends downward into the borehole 102 and/or wellbore 112. The drilling tool assembly 104 may include a drill string 105, a bottomhole assembly (“BHA”) 106, and a bit 110, attached to the downhole end of drill string 105. The wellbore 112 may be used to facilitate one or more of hydrocarbon recovery from the earth formation 101, carbon storage in the earth formation 101 (such as by injection of carbon dioxide into the earth formation 101) injection of other fluids into the earth formation 101, stimulation of geological formations for hydrogen generation and/or carbon dioxide storage, or other processes.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the borehole 102 or wellbore 112 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore 112. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 112. The bit 110 may also be a junk mill used to mill away tools, plugs, cement, other materials within the borehole 102, or combinations thereof. Swarf or other cuttings formed by use of a mill may be lifted to surface, or may be allowed to fall downhole.

During drilling operations, a wellbore fluid (e.g., a drilling fluid) may be used to facilitate lubrication and cooling of the bit 110 and removal of cuttings of the earth formation 101 from the borehole 102 and/or wellbore 112. The wellbore fluid may be configured to be circulated through the drill string 105, out of the drill string 105 through the bit 110, and into the annulus between the drill string 105 and the surfaces of the earth formation 101 defining the borehole 102 (or the wellbore 112). For example, a surface pump 114 may pump the wellbore fluid from a mud pit 116 which holds the wellbore fluid. In some embodiments, one or more additives may be added to the wellbore fluid, such as by providing the one or more additives to the mud pit 116.

The wellbore fluid may include one or more materials formulated and configured to facilitate drilling of the earth formation 101. The wellbore fluid may include an emulsifier composition including an emulsifier formulated and configured to facilitate the formation of an emulsion (e.g., a dispersion of an immiscible liquid into another) by reducing the interfacial tension between two liquids. In some embodiments, the wellbore fluid includes an emulsifier configured to form a stable water-in-oil (e.g., invert) emulsion. In some embodiments, the emulsifier includes an amidoamine. The amidoamine may include a reaction product of an amide and one or more dicarboxylic acids, such as one or more of maleic acid, maleic anhydride, fumaric acid, succinic acid, succinic anhydride, oxalic acid, malonic acid, adipic acid, azelaic acid, muconic acid, citraconic acid, itaconic acid, tartaric acid, or glutaric acid. The emulsifier composition may further include a pour point depressant including an alcohol, such as a non-polar alcohol. In some embodiments, the alcohol does not include ethoxylated alcohols. The alcohol may reduce the pour point of the emulsifier composition, facilitating the flowability of the emulsifier composition at the well site, such as from a barrel or drum to the mud pit 116. In some embodiments, the emulsifier composition is free of (e.g., substantially free of) solvents, such as base oils (e.g., diesel, a mixture of alkanes with a carbon chain length ranging from C₁₀ to C₂₀ (e.g., Saraline 185V, commercially available from Shell PLC of London, England), a mixture of C₁₆ to C₁₈ internal olefins), and/or pour point depressants (other than the wax inhibitor). For example, the emulsifier composition may be free of diesel and glycol-based pour point depressants. In other embodiments, the emulsifier composition includes the emulsifier, the alcohol pour point depressant, and a base oil formulated and configured to further reduce the pour point of the emulsifier composition.

The wellbore fluid may include a base fluid, the emulsifier composition, and optionally, one or more additives (e.g., one or more wetting agents, surfactants, bridging materials, viscosifiers, thinners (e.g., dispersion aids), weighting materials, filtration control agents, shale stabilizers, pH buffers, scavengers, emulsion activators, corrosion inhibitors, oxygen scavengers, gelling agents, shale inhibitors, foaming agents, defoamers, scale inhibitors, solvents, rheological additives, or other additives).

In some embodiments, the wellbore fluid is a non-aqueous-based drilling fluid (e.g., an oil-based drilling fluid, a synthetic-based drilling fluid) and may be referred to as a “non-aqueous fluid” (NAF), an “invert drilling fluid,” an “invert emulsion drilling fluid,” or a “drilling mud.” The wellbore fluid may include an invert emulsion wherein the continuous external phase is oleaginous, and the internal discontinuous phase is aqueous.

In embodiments where the wellbore fluid includes a non-aqueous-based wellbore fluid, such as an oil-based wellbore fluid or a synthetic-based wellbore fluid, the base fluid may include an oleaginous or oil-based fluid, such as a natural or synthetic oil. In some embodiments the oleaginous fluid is selected from the group consisting of at least one of diesel oil, mineral oil, a synthetic oil, (e.g., hydrogenated and unhydrogenated olefins including polyalpha olefins, linear and branched olefins), a mixture of alkanes with a carbon chain length ranging from C₁₀ to C₂₀ (e.g., Saraline 185V, commercially available from Shell PLC of London, England), polydiorganosiloxanes, siloxanes, organosiloxanes, or esters of fatty acids (e.g., straight chained, branched and cyclical alkyl ethers of fatty acids). In some embodiments, the base fluid includes a mixture of C₁₆ to C₁₈ internal olefins (an alkene in which the double bond is within the carbon chain rather than at a terminal portion (at the alpha position) of the carbon chain).

An internal phase of an emulsion of the oleaginous or oil-based fluid may include one or more salts. The one or more salts may provide a desired density to the drilling fluid and may also reduce the effect of the drilling fluid on hydratable clays and shales the earth formation 101. The salts may include salts of one or more of sodium, calcium, aluminum, magnesium, zinc, potassium, strontium, or lithium, and salts of one or more of chlorides, bromides, carbonates, iodides, chlorates, bromates, formates, nitrates, oxides, phosphates, sulfates, silicates, or fluorides. In some embodiments, the salt includes a divalent halide, such as an alkaline earth halide (e.g., calcium chloride (CaCl₂), calcium bromide (CaBr₂)), or a zinc halide. The salt may include cesium formate (HCOOR), sodium bromide (NaBr), potassium bromide (KBr), and cesium bromide (CsBr). The particular composition of the salt may be selected based on compatibility with the earth formation 101 and/or to match the brine phase of a completion fluid and/or a non-aqueous fluid. In some embodiments, the salt includes calcium chloride.

The salt may constitute from about 5.0 weight percent to about 30.0 weight percent of the wellbore fluid, such as from about 5.0 weight percent to about 10.0 weight percent, from about 10.0 weight percent to about 20.0 weight percent, or from about 20.0 weight percent to about 30.0 weight percent of the wellbore fluid. However, the disclosure is not so limited, and the weight percent of the salt and the water in the wellbore fluid may be different than that described.

As described above, wellbore fluid may include an emulsifier composition including the emulsifier and the pour point depressant. The emulsifier may be formulated and configured to reduce an amount of wellbore fluid (e.g., the drilling fluid) lost in the earth formation 101, such as during circulation of the wellbore fluid through the borehole 102 and/or the wellbore 112 during drilling operations. For example, the emulsifier may facilitate formation of an emulsion by reducing the interfacial tension between the oleaginous phase and the aqueous phase of the wellbore fluid. In some embodiments, the emulsifier facilitates formation of a water-in-oil (e.g., an invert) emulsion. In addition to the emulsifier, the emulsifier composition may further include the alcohol pour point depressant, which may facilitate a reduction of the pour point and the viscosity of the emulsifier composition.

The emulsifier may include one or more of an amidoamine, an amide, an oleate ester, a polyamide, a polyamine, an imidazoline, an imidazoline derivative, or another material. In some embodiments, the emulsifier includes an amidoamine. In some embodiments, the amidoamine is based on one or more polyalkylamines, such as one or more of diethylenetriamine (DETA), triethylenetetramine (TETA), tetraethylene pentaamine (PETA), and pentaethylenehexamine (PEHA). In some embodiments, the emulsifier includes a DETA-based amidoamine.

The emulsifier may include an amide including a reaction product of one or more polyamines and one or more fatty acids. The polyamine may include at least one terminal amine group. In some embodiments, the polyamine includes two terminal amine groups. In some embodiments, the polyamine includes a polyalkylamine including a compound having alternating amine and alkyl groups. The alkyl groups of the polyalkylamine may be linear or branched. By way of non-limiting example, the polyalkylamine may include at least one of diethylenetriamine, triethylenetetramine, tetraethylene pentaamine, or pentaethylenehexamine.

In some embodiments, the polyalkylamine includes a symmetrical compound. In some embodiments, the polyamine includes an alkanolamine (amino alcohol) including more than one amine group, such as such as aminoethylethanolamine (AEEA). In some embodiments, the polyamine includes dipropylenetriamine, propylenebutylenetriamine, spermidine, spermine, hexamethylenediamine, a polyethylenimine, or another polyamine. In some embodiments, the polyamine is selected from the group consisting of at least one of diethylenetriamine, triethylenetetramine, tetraethylene pentaamine, pentaethylenehexamine, and aminoethylethanolamine.

The fatty acid that is reacted with the polyalkylamine to form the amide may be saturated or unsaturated, and may be linear, branched, or include one or more cyclic groups. By way of non-limiting example, the fatty acid may include one or more of valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, behenic acid, tricosylic acid, lignoceric acid, pentacosylic acid, cerotic acid, carboceric acid, montanic acid, nonacosylic acid, meliisic acid, lacceroic acid, psyllic acid, linolenic acid, stearidonic acid, eicosapentaenoic acid, cervonic acid, linoleic acid, linolelaidic acid, arachidonic acid, docosatetranoic acid, palmitoleic acid, vaccenic acid, paullinic acid, oleic acid, elaidic acid, erucic acid, crotonic acid, myristoleic acid, sapienic acid, gadoleic acid, or eicosenoic acid.

In some embodiments, the fatty acid is a saturated fatty acid (e.g., one or more of valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, behenic acid, tricosylic acid, lignoceric acid, pentacosylic acid, cerotic acid, carboceric acid, montanic acid, nonacosylic acid, meliisic acid, lacceroic acid, psyllic acid). In other embodiments, the fatty acid is an unsaturated fatty acid (e.g., one or more of linolenic acid, stearidonic acid, eicosapentaenoic acid, cervonic acid, linoleic acid, linolelaidic acid, arachidonic acid, docosatetranoic acid, palmitoleic acid, vaccenic acid, paullinic acid, oleic acid, elaidic acid, erucic acid, crotonic acid, myristoleic acid, sapienic acid, gadoleic acid, and eicosenoic acid). The unsaturated fatty acid may be a monounsaturated fatty acid having one carbon to carbon double bond; a di-unsaturated fatty acid having two carbon to carbon double bonds; a tri-unsaturated fatty acid having three carbon to carbon double bonds; a tetra-unsaturated fatty acid having four carbon to carbon double bonds; a penta-unsaturated fatty acid having five carbon to carbon double bonds; a hexa-unsaturated fatty acid having six carbon to carbon double bonds; or a polyunsaturated fatty acid having more than six carbon to carbon double bonds.

In some embodiments, the fatty acid comprises, consists essentially of, or consists of tall oil fatty acid (TOFA) including one or more of oleic acid, linoleic acid, palmitic acid, and stearic acid. In some embodiments, the fatty acid comprises, consists essentially of, or consists of a mixture of oleic acid and linoleic acid. In some embodiments, the fatty acid comprises, consists essentially of, or consists of oleic acid.

In some embodiments, the amide is symmetrical. In some embodiments, the amide is a bis-amide including two amide groups and at least one central amine between the two amide groups. The amide groups may be terminal groups and may be bonded to the group corresponding to the fatty acid used to form the bis-amide.

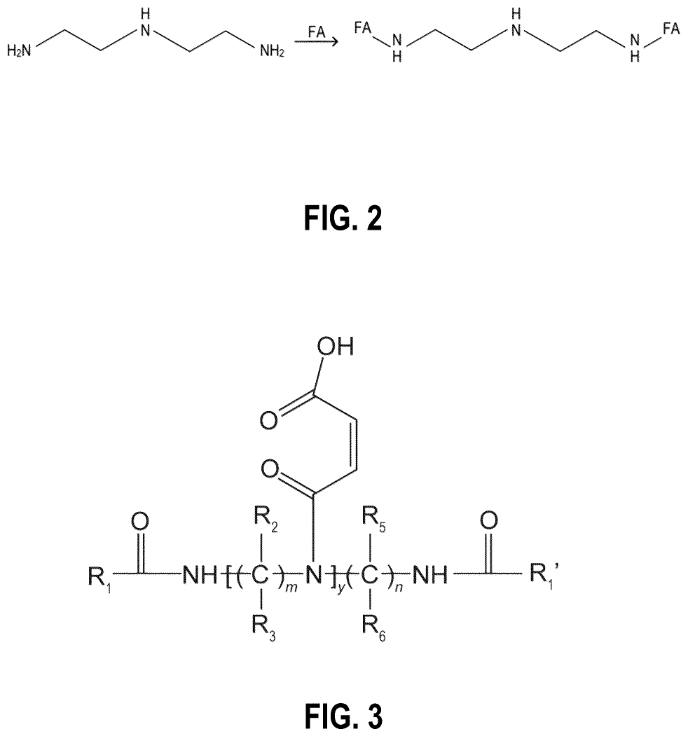

As described above, the amide may include a reaction product of the polyamine and the fatty acid. In some embodiments, the reaction between the polyamine and the fatty acid is a condensation reaction. For example, where the polyalkylamine includes DETA, the amide may include a bis-amide formed according to the reaction scheme (I) illustrated below, which is also illustrated in FIG. 2.

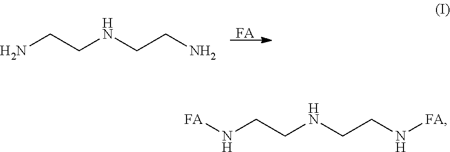

wherein FA in the amide reaction product corresponds to the fatty acid, but without the hydroxyl group of the fatty acid since the hydroxyl group is removed during the condensation reaction between the polyalkylamine and the fatty acid. For example, where the fatty acid includes oleic acid, FA in the amide in reaction scheme (I) includes an oleate group (e.g., CH₃(CH₂)₇CH═CH(CH₂)₇C(═O)—), wherein the carbonyl carbon is bonded to the nitrogen atom of the amide group. Similarly, FA—N— in reaction scheme (I) includes a fatty acid amide group. As one example, where the fatty acid includes oleic acid, FA—N— includes an oleamide group. In embodiments including a bis-amide, the fatty acids of the bis-amide may be the same and the amide groups may be the same. In other embodiments, the fatty acids of the bis-amide are different than one another and the corresponding amide groups are different than one another.

In some embodiments, the emulsifier includes a reaction product of the amide (e.g., the bis-amide) and a dicarboxylic acid. The reaction product may be referred to herein as an acid-substituted amidoamine. The acid-substituted amidoamine may be heat treated to form one or more isomers thereof. In some such embodiments, each of the acid-substituted amidoamine and the isomers thereof individually include two fatty acid amides and a tertiary amine bonded to a carboxylic acid group. The tertiary amine may be between the two fatty acid amides. The dicarboxylic acid may include at least one of maleic acid, maleic anhydride, fumaric acid, succinic acid, succinic anhydride, oxalic acid, malonic acid, adipic acid, azelaic acid, muconic acid, citraconic acid, itaconic acid, tartaric acid, or glutaric acid.

In some embodiments, the emulsifier includes the reaction product of an amide (the amide comprising a reaction product of one or more polyalkylamines and one or more fatty acids, as described above) and a dicarboxylic acid. In embodiments where the dicarboxylic acid includes maleic acid, the emulsifier includes the general structure shown in structure (II) below, which is also illustrated in FIG. 3.

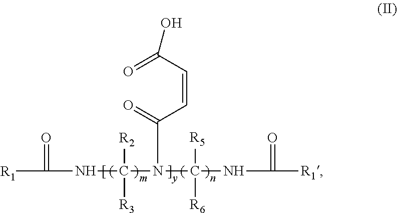

wherein R₁ and R₁′ individually comprise a C₄ to C₃₀ hydrocarbyl group based on the fatty acid used to form the amide; R₂, R₃, R₅, and R₆ are independently hydrogen (H), or C₁ to C₄ alkyl groups, C₁ to C₄ alkoxyalkyl groups, or C₁ to C₄ hydroxyalkyl groups; n and m are integers from 1 to 10; and y is an integer from 1 to 5. In some embodiments, R₁ and R₁′ are the same. In other embodiments, R₁ and R₁′ are different. In some embodiments, m and n are the same integer.

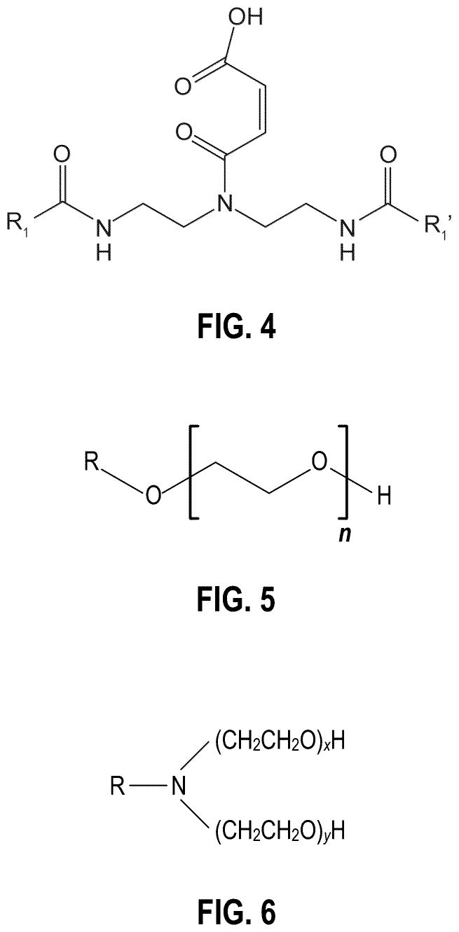

In some embodiments, each of R₂, R₃, R₅, and R₆ comprise hydrogen; m and n are 2; and y is 1. In some such embodiments, the amide from which the emulsifier is formed comprises a reaction product of a fatty acid and diethylenetriamine. Where the amide includes a reaction product of a fatty acid and diethylenetriamine; and the dicarboxylic acid to form the acid-substituted amidoamine is maleic acid, the reaction product of the amide and the maleic acid has the structure shown in structure (III) below, which is also illustrated in FIG. 4.

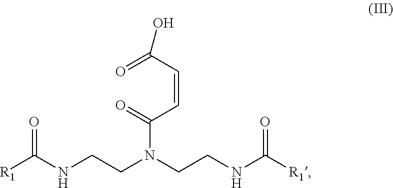

Of course, the acid-substituted amidoamine of structure (II) and/or structure (III) may be substituted with other dicarboxylic acids or other materials, such as maleic anhydride, fumaric acid, succinic acid, succinic anhydride, oxalic acid, malonic acid, adipic acid, azelaic acid, muconic acid, citraconic acid, itaconic acid, tartaric acid, or glutaric acid. In some embodiments, the emulsifier may further include glycerin (C₃H₈O₃), such as in embodiments where the fatty acids used to form the amide are formed from vegetable oils.

Accordingly, in some embodiments, the emulsifier includes an amidoamine including a reaction product of the amide and the dicarboxylic acid. The emulsifier may include at least one amide group and at least one amine group, such as a secondary amine group or a tertiary amine group.

The emulsifier may constitute from about 40.0 weight percent to about 80.0 weight percent of the emulsifier composition, such as from about 40.0 weight percent to about 50.0 weight percent, from about 50.0 weight percent to about 60.0 weight percent, from about 60.0 weight percent to about 70.0 weight percent, or from about 70.0 weight percent to about 80.0 weight percent of the emulsifier composition. In some embodiments, and as described herein, the pour point depressant including a non-polar alcohol may facilitate forming the emulsifier composition to include a higher weight percent of emulsifier than emulsifier compositions that do not include the alcohol-based pour point depressants described herein. The non-polar alcohol pour point depressant may facilitate forming the emulsifier composition to include a greater percent of active components (e.g., the emulsifier) while still exhibiting a pour point less than about 0° C., such as less than about −5° C., less than about −10° C., less than about −15° C., less than about −20° C., or less than about −25° C. and while exhibiting a viscosity that is desirable for pourability.

In some embodiments, the emulsifier comprises a paste at room temperature (about 20° C.) and has a melting temperature within a range of from about 30° C. (about 86° F.) to about 50° C. (about 122° F.), such as from about 30° C. (about 86° F.) to about 40° C. (about 104° F.), or from about 40° C. (about 104° F.) to about 50° C. (about 122° F.). In some embodiments, the melting temperature of the emulsifier is within a range of from about 37.8° C. (about 100° F.) to about 45° C. (about 110° F.). As described herein, the pour point depressant may solubilize the emulsifier and the emulsifier may be soluble in the pour point depressant at room temperature, reducing the pour point of the emulsifier composition including the pour point depressant.

As described above, the emulsifier composition may include the pour point depressant. The pour point depressant may be formulated and configured to reduce the pour point and the viscosity of the emulsifier composition. For example, the emulsifier composition with the pour point depressant may exhibit a lower pour point than the emulsifier composition (e.g., the emulsifier) without the pour point depressant. In addition, the pour point depressant may reduce or prevent hydrogen bonding between molecules of the emulsifier. Disruption of hydrogen bonding of the emulsifier caused by the pour point depressant may reduce and/or prevent crystallization of the emulsifier.

The pour point depressant may include one or more alcohols. In some embodiments, the pour point depressant may include alcohols including a single hydroxyl group and not including more than one hydroxyl group. In some embodiments, the pour point depressant is free of alcohols that include two hydroxyl groups. Without being bound by any particular theory, it is believed that selecting the pour point depressant to include alcohols having a single hydroxyl group facilitates the use of a non-polar pour point depressant (or a pour point depressant having a lower polarity than pour point depressants including more than one hydroxyl group), which improves the properties of wellbore fluids including the pour point depressant. In some embodiments, the pour point depressant may be formed of alcohols having zero or one ether groups, such as zero or one alkylene oxide groups (e.g., ethylene oxide group (—OCH₂CH₂—)). The pour point depressant may be selected to exhibit a polarity less than a polarity of glycol-based pour point depressants, such as BTG and BDG. For example, the pour point depressant may be selected to include alcohols having a lower HLB value than BTG and BGD.

The HLB may be a measure of a degree of hydrophilicity or lipophilicity of a material and may be determined by calculating the percentages of molecular weights of the hydrophilic portions and the lipophilic portions of the material. HLB values less than 10 may be an indication that a material (molecule) is lipid-soluble, while an HLB value greater than 10 may be an indication that the material is water-soluble. For example, for nonionic molecules the HLB value may be determined according to the Griffin-based Equation (1) below:

$$HLB = 20 \times {MW}_{H} / ( {MW}_{H} + {MW}_{L} ) ; \qquad Equation ( 1 )$$

wherein MW_{H} is the molecular weight of the hydrophilic portions (the hydrophile) of the material and MW_{L} is the molecular weight of the hydrophobic (lipophilic) portions (the hydrophobe) of the material. In Equation (1), the sum of MW_{H} and MW_{L} is the total molecular weight of the molecule for which the HLB is being calculated (i.e., MW_{H}+MW_{L}=total molecular weight). According to Equation (1), the HLB of BTG is about 12.8, the HLB of BDG is about 10.9, and the HLB of diethylene glycol monohexyl ether is about 9.4. In some embodiments, the HLB of the pour point depressants described herein may be less than about 10.0, such as less than about 9.0, less than about 8.6, less than about 8.5, less than about 8.0, less than about 7.0, less than about 6.0, less than about 5.0, or less than about 4.0. As used herein, the hydrophilic portions of the pour point depressant include the portions of the pour point depressant that include the hydrophilic head of the molecule, which may include ethylene oxide groups; and the hydrophobic portions include the hydrophobic tail of the molecule, the alcohol group (—OH group), and propylene oxide groups (if present). Accordingly, increasing the ethoxylation of the pour point depressant may increase the HLB of the pour point depressant since the ethylene oxide groups are considered to be hydrophilic portions. Ethoxylation may increase the HLB, but may also increase the flash point of the pour point depressant. Accordingly, the HLB of a pour point depressant may be reduced by replacing an ethylene oxide group with a propylene oxide group, or including a propylene oxide group in an alcohol.

As one example, the hydrophilic portion of BTG may include the three ethylene oxide groups and have a molecular weight of about 132.2 g/mol and BTG may have a total molecular weight of about 206.3 g/mol. The HLB of BTG may be equal to 20 times 132.2 divided by 206.3 (i.e., 20×(132.2/206.3)=12.8). Similarly, the molecular weight of the hydrophilic portions of the BDG may be equal to about 88 g/mol (the molecular weight of the two ethylene oxide groups is about 88 g/mol) and the molecular weight of BDG is about 162 g/mol. The HLB of BDG may be equal to 20 times 88 g/mol divided by 162 g/mol (i.e., 20×(88/162)=10.9). As yet another example, the HLB value of diethylene glycol monohexyl ether may be 9.4. For example, the molecular weight of the hydrophilic portion of diethylene glycol monohexyl ether may be about 89.11 g/mol (e.g., the hydrophilic portion including 2 oxygen atoms, 4 carbon atoms, and 9 hydrogen atoms) and the hydrophobic portions having a molecular weight of about 101.15 (the hydrophobic portion having 6 carbon atoms, 13 hydrogen atoms, and 1 oxygen atom). The HLB value of the diethylene glycol monohexyl ether may be about 9.4 (i.e., 89.11/(89.11+101.15)=9.4).

The alcohol may include one or more C₅ to C₁₃ alcohols. In some embodiments, the alcohol includes fewer than thirteen carbon atoms. In some embodiments, the alcohol includes one or more linear alcohols. In some embodiments, the alcohol includes one or more C₅ to C₈ alcohols and is substantially free of alcohols having more than eight carbon atoms. The alcohol may be a terminal alcohol wherein the hydroxyl group is at a terminal end of an alkyl chain. In other words, the hydroxyl group may be bonded to the alpha (a) carbon. In some embodiments, the hydroxyl group is not bonded to the alpha carbon atom and may be bonded to a second carbon atom of an alkyl chain. In some embodiments, the pour point depressant comprises, consists essentially of, or consists of a single alcohol, such as 2-octanol. In some embodiments, the pour point depressant includes a hydroxyl group bonded to a second (β) carbon atom of an alcohol. In some embodiments, the pour point depressant includes a hydroxyl group bonded to a tertiary carbon atom (wherein the carbon atom bonded to the alcohol group is bonded to three other carbon atoms (and not to any hydrogen atom)), such as tert-amyl alcohol or ethoxylated or propoxylated tert-amyl alcohol. Without being bound by any particular theory, it is believed that alcohols wherein the hydroxyl group is bonded to the second carbon atom of the chain facilitates disruption of self assembly of the alcohol in the emulsifier composition, reducing the viscosity of the emulsifier composition including such alcohols.

The alcohol may include one or more C₅ to C₁₃ primary alcohols having the general formula R₁—OH; one or more C₅ to C₁₃ secondary alcohols having the general formula R₁—CH(OH)—R₂; one or more C₅ to C₁₃ tertiary alcohols having the general formula R₁—CR₃(OH)—R₂; or combinations thereof. Each of R₁, R₂, and R₃ may independently include hydrogen, or a hydrocarbon having from 1 carbon atom to 12 carbon atoms, may be linear or branched, and may be saturated or unsaturated. In some embodiments, R₁, R₂, and R₃ are independently linear and may be saturated. Each of R₁, R₂, and R₃ may independently include a hydrocarbyl group and may be the same, or one or more of R₁, R₂, and R₃ may be different than another of R₁, R₂, and R₃. In some embodiments, each of R₁, R₂, and R₃ independently include a linear, unsubstituted hydrocarbyl group, such as a linear, unsubstituted alkyl group.

Non-limiting examples of the alcohol of the pour point depressant include one or more of tert-amyl alcohol, hexanol (e.g., 1-hexanol, 2-hexanol), cyclohexanol, heptanol (e.g., 1-heptanol, 2-heptanol, 3-heptanol), octanol (e.g., 1-octanol, 2-octanol, 3-octanol, 4-octanol), nonanol (e.g., 1-nonanol, 2-nonanol 3-nonanol, 4-nonanol, 5-nonanol), decanol (e.g., 1-decanol, 2-decanol, 3-decanol, 4-decanol, 5-decanol), undecanol (e.g., 1-undecanol, 2-undecanol, 3-undecanol, 4-undecanol, 5-undecanol, 6-undecanol), dodecanol (e.g., 1-dodecanol, 2-dodecanol, 3-dodecanol, 4-dodecanol, 5-dodecanol, 6-dodecanol), tridecanol (e.g. 1-tridecanol, 2-tridecanol, 3-tridecanol, 4-tridecanol, 5-tridecanol, 6-tridecanol, 7-tridecanol), 2-butyl-1-octanol, isotridecanol, 2,3-methyl-1-hexyn-3-ol, 2-methyl-3-butene-1-ol, benzyl alcohol, 4-hydroxybenzyl alcohol, 2-ethyl hexanol, a mixture of C₁₀ to C₁₆ primary alcohols, a mixture of C₁₄ to C₁₈ primary alcohols, ethylene glycol monohexyl ether (such as Hexyl Cellosolve™, commercially available from The Dow Chemical Company of Midland, Michigan), diethylene glycol monohexyl ether (such as Hexyl Carbitol™, commercially available from The Dow Chemical Company of Midland, Michigan), a C₆-C₁₂ ethoxylated alcohol (such as Novel® 810-2 commercially available from Sasol of Johannesburg, South Africa), C₅-C₁₂ ethoxylated alcohols, a benzylic ethoxylate, C₅ to C₁₂ propoxylated alcohols, a Guerbet alcohol comprising a primary alcohol with beta branching (such as a C₈ Guerbet alcohol), a nonionic alkoxylated alcohol (such as Genapol BA 040, commercially available from Clariant of Muttenz, Switzerland), di-n-hexyl ether, a polyoxyethylene (3) oleyl ether (such as Brik O3, commercially available from Croda International Plc of the Yorkshire, United Kingdom), tert-amyl alcohol, benzyl alcohol, salicyl alcohol, or another alcohol.

In some embodiments, the pour point depressant includes a C₆ to C₁₃ linear alcohol, such as a C₆ to C₁₂ linear alcohol. In some embodiments, the pour point depressant includes a C₈ to C₁₁ linear alcohol. In some embodiments, the pour point depressant includes one or more of octanol, nonanol, decanol, or undecanol.

In some embodiments, the pour point depressant includes one or more ethoxylated alcohols. The ethoxylated alcohols may be C₅ to C₁₃ ethoxylated alcohols and have the general formula R—(OCH₂CH₂)ₙ—OH, wherein n is an integer and is 2 or less, and R is a hydrocarbyl group, such as a linear, branched, or cyclic alkyl group and may be saturated or unsaturated. In some embodiments, n is equal to 1 and the ethoxylated alcohol includes only one ethylene oxide group. A total number of carbon atoms of the ethoxylated alcohol may be less than 13. As used herein, ethoxylated alcohols have the general formula R—(OCH₂CH₂)ₙ—OH, wherein the number of carbon atoms of the R group corresponds to the number of the ethoxylated alcohol. For example, a C₅ ethoxylated alcohol includes an R group having 5 carbon atoms and one or more ethylene oxide groups bonded to the R group. For example, a C₅ ethoxylated alcohol including one ethylene oxide group may include a total of 7 carbon atoms (5 carbon atoms in the alkyl chain and two carbon atoms in the one ethylene oxide group). The pour point depressant may include a C₅ to C₁₂ ethoxylated alcohol, such as a C₅ to C₁₀, or a C₅ to C₈ ethoxylated alcohol. In some embodiments, the pour point depressant includes a C₅ to C₁₀ alkoxylated (e.g., ethoxylated) alcohol. In some embodiments, the pour point depressant includes a C₅ to C₈ alkoxylated (e.g., ethoxylated) alcohol. In some embodiments, the ethoxylated alcohol includes less than 12 total carbon atoms, such as less than 10 total carbon atoms, or less than 8 total carbon atoms. By way of non-limiting example, the ethoxylated alcohol may include one or more of ethylene glycol monomethyl ether, 1-ethoxyethanol, 1-propoxyethanol, 1-butoxyethanol, 1-pentyloxybutanol, 1-hexyloxyethanol, 1-hepyloxyethanol, 1-octyloxyethanol, 1-nonyloxyethanol, 1-decyloxyethanol, 1-undecyloxyethanol, 2-ethoxyethanol, 2-propoxyethanol, 2-butoxyethanol, 2-pentyloxybutanol, 2-hexyloxyethanol (also referred to as ethylene glycol monohexyl ether), 2-hepyloxyethanol, 2-octyloxyethanol, 2-nonyloxyethanol, 2-decyloxyethanol, or 2-undecyloxyethanol, vanillyl alcohol, or another ethoxylated alcohol. In some embodiments, the pour point depressant includes an alcohol having fewer than thirteen carbon atoms and includes less than two ethylene oxide groups.

In some embodiments, the pour point depressant includes one or more propoxylated alcohols, such as C₅ to C₁₂ propoxylated alcohols. The propoxylated alcohols may have the general formula R—(OCH₂CH₂CH₂)ₙ—OH, wherein n is 1 or 2, and R is the same as described above with reference to the ethoxylated alcohols. As used herein, propoxylated alcohols have the general formula R—(OCH₂CH₂CH₂)ₙ—OH, wherein the number of carbon atoms of the R group corresponds to the number of the propoxylated alcohol. For example, a C₅ propoxylated alcohol includes an R group having 5 carbon atoms and one or more propylene oxide groups bonded to the R group. For example, a C₅ propoxylated alcohol includes one propylene oxide group may include a total of 8 carbon atoms. In some embodiments, the pour point depressant includes a C₅ to C₉ propoxylated alcohol. In some embodiments, the pour point depressant includes a C₅ to C₆ propoxylated alcohol.

In some embodiments, the pour point depressant is free of (does not include, is substantially free of) ethoxylated alcohols. The pour point depressant may be free of (not include) ether groups. In some embodiments, the pour point depressant is free of (does not include, is substantially free of) glycols. In some embodiments, the pour point depressant includes alcohols including a single ethylene oxide group (—OCH₂CH₂—) and/or alcohols including a single propylene oxide group (—OCH₂CH₂CH₂—) and is free of alcohols including more than one ethylene oxide group.

In some embodiments, the pour point depressant includes one or more alcohols that are not ethoxylated or propoxylated and further includes one or more alkoxylated alcohols (e.g., one or more ethoxylated alcohols and/or one or more propoxylated alcohols). The alkoxylated alcohols may be C₅ to C₁₃ alkoxylated alcohols and/or C₅ to C₁₃ propoxylated alcohols, as described above. In some embodiments, the alkoxylated alcohol includes only one ethylene oxide group or only one propylene oxide group. In embodiments where the pour point depressant includes a non-alkoxylated alcohol and an alkoxylated alcohol, the pour point depressant includes from about 0.1 part by weight to about 10.0 parts by weight of the non-alkoxylated alcohol for every about 1.0 part by weight of the alkoxylated alcohol. For example, the pour point depressant may include from about 0.1 part by weight to about 0.5 part by weight, from about 0.5 part by weight to about 1.0 part by weight, from about 1.0 part by weight to about 2.0 parts by weight, from about 2.0 parts by weight to about 5.0 parts by weight, or from about 5.0 parts by weight to about 10.0 parts by weight for every about 1.0 part by weight of the alkoxylated alcohol.

In some embodiments, the pour point depressant includes more than one alcohol. For example, the pour point depressant may include a first alcohol and at least a second alcohol. In some embodiments, the first alcohol includes a non-alkoxylated alcohol and the second alcohol includes a second non-alkoxylated alcohol. In other embodiments, the first alcohol includes a non-alkoxylated alcohol and the second alcohol includes an alkoxylated alcohol. In further embodiments, the first alcohol includes a first alkoxylated alcohol and the second alcohol includes a second alkoxylated alcohol. In some such embodiments, each of the first alcohol and the at least a second alcohol may independently constitute from about 5.0 weight percent to about 95.0 weight percent of the pour point depressant, such as from about 5.0 weight percent to about 10.0 weight percent, from about 10.0 weight percent to about 20.0 weight percent, from about 20.0 weight percent to about 40.0 weight percent, from about 40.0 weight percent to about 60.0 weight percent, from about 60.0 weight percent to about 80.0 weight percent, from about 80.0 weight percent to about 90.0 weight percent, or from about 90.0 weight percent to about 95.0 weight percent of the pour point depressant.

In some embodiments, the pour point depressant may include at least three types of alcohols, each of which may independently be a non-ethoxylated alcohol (e.g., a primary alcohol, a secondary alcohol, or a tertiary alcohol), or an alkoxylated alcohol. The pour point depressant may comprise, consist essentially of, or consist of a first alcohol, a second alcohol, and a third alcohol.

The pour point depressant may be selected such that the emulsifier composition exhibits a desired pour point, a desired viscosity, and a desired flash point. For example, selecting the pour point depressant to include a relatively lower molecular weight alcohol, such as a relatively low molecular weight non-alkoxylated alcohol, may facilitate forming the emulsifier composition to exhibit a relatively low viscosity, but a higher flash point than emulsifier compositions including pour point depressants having a higher molecular weight or that are ethoxylated. In some embodiments, the pour point depressant comprises, consists essentially of, or consists of 2-octanol. In some embodiments, the pour point depressant comprises, consists essentially of, or consists of 2-nonanol, 2-decanol, 2-undecanol, and/or isomers thereof.

A molecular weight of each alcohol of the pour point depressant may be within a range of from about 75 g/mol to about 250 g/mol, such as from about 75 g/mol to about 100 g/mol, from about 100 g/mol to about 125 g/mol, from about 125 g/mol to about 150 g/mol, from about 150 g/mol to about 175 g/mol, from about 175 g/mol to about 200 g/mol, from about 200 g/mol to about 225 g/mol, or from about 225 g/mol to about 250 g/mol. The molecular weight of the alcohols may be less than about 250 g/mol, such as less than about 225 g/mol, less than about 200 g/mol, less than about 175 g/mol, less than about 150 g/mol, less than about 125 g/mol, or less than about 100 g/mol.

The pour point depressant may constitute from about 1.0 weight percent to about 20.0 weight percent of the emulsifier composition, such as from about 1.0 weight percent to about 2.0 weight percent, from about 2.0 weight percent to about 3.0 weight percent, from about 3.0 weight percent to about 5.0 weight percent, from about 5.0 weight percent to about 7.5 weight percent, from about 7.5 weight percent to about 10.0 weight percent, from about 10.0 weight percent to about 15.0 weight percent, or from about 15.0 weight percent to about 20.0 weight percent of the emulsifier composition. In some embodiments, the pour point depressant constitutes less than about 20.0 weight percent of the emulsifier composition, such as less than about 15.0 weight percent, less than about 10.0 weight percent, less than about 7.5 weight percent, or less than about 5.0 weight percent of the emulsifier composition.

The emulsifier composition may further include a wetting agent and/or a rheology modifier. The wetting agent may include one or more fatty acids. In some embodiments, the wetting agent includes a mixture of fatty acids, such as a mixture of unsaturated fatty acids and saturated fatty acids. The wetting agent may comprise, consist essentially of, or consist of a mixture of fatty acids including one or more unsaturated fatty acids. In some embodiments, the wetting agent includes at least one unsaturated fatty acid and at least one saturated fatty acid. In some embodiments, the wetting agent is substantially free of saturated fatty acids and comprises, consists essentially of, or consists of one or more unsaturated fatty acids.

The wetting agent may include naturally sourced fatty acids which may be linear, branched, or may include one or more cyclic groups. The unsaturated fatty acids may include a monounsaturated fatty acid having one carbon to carbon double bond; a di-unsaturated fatty acid having two carbon to carbon double bonds; a tri-unsaturated fatty acid having three carbon to carbon double bonds; a tetra-unsaturated fatty acid having four carbon to carbon double bonds; a penta-unsaturated fatty acid having five carbon to carbon double bonds; a hexa-unsaturated fatty acid having six carbon to carbon double bonds; or a polyunsaturated fatty acid having more than six carbon to carbon double bonds. In some embodiments, the wetting agent includes one or more monounsaturated fatty acids, one or more di-unsaturated fatty acids, and one or more tri-unsaturated fatty acids.

The wetting agent may include one or more unsaturated fatty acids including one or more of linolenic acid (e.g., α-linolenic acid and/or γ-linolenic acid), stearidonic acid, eicosapentaenoic acid, cervonic acid, linoleic acid, linolelaidic acid, arachidonic acid, docosatetranoic acid, palmitoleic acid, vaccenic acid, paullinic acid, oleic acid, elaidic acid, erucic acid, crotonic acid, myristoleic acid, sapienic acid, gadoleic acid, or eicosenoic acid. In some embodiments, the unsaturated fatty acid includes one or more unsaturated C₁₈ fatty acids, such as one or more of oleic acid, linoleic acid, linolelaidic acid, α-linolenic acid, γ-linolenic acid, or stearidonic acid. In some embodiments, the wetting agent includes unsaturated fatty acids including each of oleic acid, linoleic acid, and a-linolenic acid. By way of non-limiting example, the wetting agent may include crude tall oil-based wetting agents (CTO-based wetting agents), distilled tall oil-based wetting agents (DTO-based wetting agents), tall oil-based wetting agents, or combinations thereof. In some embodiments, the wetting agent includes some rosin, which may be present from the source from which the fatty acids are derived. For example, DTO-based wetting agents may include up to about 30.0 weight percent rosin, but the amount of rosin may depend on the source.

When the emulsifier composition includes the wetting agent, the wetting agent may constitute from about 1.0 weight percent to about 50.0 weight percent of the emulsifier composition, such as from about 1.0 weight percent to about 5.0 weight percent, from about 5.0 weight percent to about 10.0 weight percent, from about 10.0 weight percent to about 20.0 weight percent, from about 20.0 weight percent to about 30.0 weight percent, from about 30.0 weight percent to about 40.0 weight percent, or from about 40.0 weight percent to about 50.0 weight percent of the emulsifier composition.

The emulsifier composition may further include a rheology modifier. The rheology modifier may include one or more of an alcohol ethoxylate, an amine ethoxylate, an ethylene oxide/propylene oxide copolymer, C₃₆ dimer acids, C₅₄ trimer acids, another material and may exhibit a hydrophilic-lipophilic balance from about 4 to about 10, such as from about 5 to about 9, or from about 6 to about 8. The rheology modifier may be formulated and configured to thin the emulsifier composition at relatively cold temperatures, while also exhibiting long term stability at elevated temperatures that may be encountered in the wellbore 112.

Alcohol ethoxylates of the rheology modifier may include the following structure shown in structure (IV), which is also illustrated in FIG. 5.

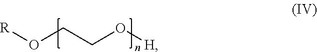

wherein R is a C₁₀ to C₂₈ alkyl group that may be linear, branched, saturated, or unsaturated and n is within a range from 2 to 6. Non-limiting examples of alcohol ethoxylates of the rheology modifier include oleyl alcohol-2-ethyoxylate, oleyl alcohol-3-ethyoxylate, oleyl alcohol-5-ethyoxylate, stearyl alcohol-2-ethyoxylate, stearyl alcohol-3-ethyoxylate, lauryl alcohol-4-ethyoxylate, and tridecyl alcohol-3-ethyoxylate. In addition, the rheology modifier may include an alcohol propoxylate, wherein the ethylene oxide group of structure (IV) is replaced with a propylene oxide (—OCH₂CH₂CH₂—).

The rheology modifier may include an amine ethoxylate or an amine propoxylate. Amine ethoxylates may have the general structure shown below in structure (V), which is also illustrated in FIG. 6.

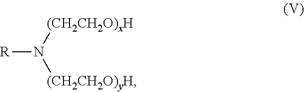

wherein R is a C₁₀ to C₂₆ alkyl group that may be linear, branched, saturated, or unsaturated, and x+y ranges from 2 to 15, such as from 2 to 10. In addition, the rheology modifier may include an amine propoxylate, wherein ethylene oxide groups of structure (V) are replaced with propylene oxide groups. By way of non-limiting example, the amine ethoxylate may be selected from PEG-2 oleylamine, PEG-2 cocoamine, PPG-2 cocoamine, PEG 15 cocoamine, PEG 5 tallow diamine, PEG-2 tallow amine, and PEG-5 tallow amine.

The rheology modifier may include at least one ethylene oxide/propylene oxide copolymer selected from a poly(ethylene glycol)-block-poly(propylene glycol)-block-poly(ethylene glycol) or ethylene diamine ethylene oxide/propylene oxide copolymer. The poly(ethylene glycol)-block-poly(propylene glycol)-block-poly(ethylene glycol) may have a molecular weight from about 1,000 to about 5,000. The ethylene diamine ethylene oxide/propylene oxide copolymer may be, for example, ethylenediamine tetrakis(propoxylate-block-ethoxylate) tetrol, or an ethylenediamine tetrakis(ethoxylate-block-propoxylate) tetrol. Such ethylene diamine ethylene oxide/propylene oxide copolymers may have a molecular weight ranging from, for example from about 3,000 to about 10,000.

The rheology modifier may include one or more other materials, such as alkyl sulfonates, amine ethers (including primary amine ethers, such as ROCH₂CH₂CH₂NH₂, and ether diamines, such as ROCH₂CH₂CH₂NHCH₂CH₂CH₂NH₂, wherein R is selected from C₆ to C₁₈ and may be linear or branched, saturated or unsaturated), amide ethoxylates, a polyester condensation polymer (produced, for example, from condensation reaction of a hydroxy-fatty acid), a polyamine condensation polymer, a fatty polycarboxylic acid, polyether siloxanes, or aluminum salts of fatty acids.

In some embodiments, the rheology modifier includes one or more C₃₆ dimer acids (a bifunctional fatty acid), one or more C₅₄ trimer acids (a trifunctional fatty acid), or a combination thereof. The C₃₆ dimer acid and the C₅₄ trimer acid may individually be acyclic, cyclic, aromatic, and/or polycyclic. In some embodiments, the rheology modifier comprises, consists essentially of, or consists of the C₃₆ dimer acid. In other embodiments, the rheology modifier comprises, consists essentially of, or consists of the C₅₄ dimer. The trimer acid may include an acid having the formula C₅₄H₅₆O₆ and may be based on tall oil fatty acid (TOFA). The dimer acid may include an acid having the formula C₃₆H₆₈O₄ and may be based on TOFA. The rheology modifier may include from about 0.1 part by weight to about 10.0 parts by weight of the C₃₆ dimer for every about 1.0 part by weight of the C₅₄ trimer, such as from about 0.1 part to about 0.5 part, from about 0.5 part to about 1.0 part, from about 1.0 part to about 2.0 parts, from about 2.0 parts to about 5.0 parts, or from about 5.0 parts to about 10.0 parts by weight of the C₃₆ dimer for every about 1.0 part by weight of the C₅₄ trimer. However, the disclosure is not so limited and the rheology modifier may include different amounts of the dimer and the trimer than that described.

When present in the emulsifier composition, the rheology modifier may constitute from about 0.10 weight percent to about 20.0 weight percent of the emulsifier composition, such as from about 0.10 weight percent to about 1.0 weight percent, from about 1.0 weight percent to about 5.0 weight percent, from about 5.0 weight percent to about 10.0 weight percent, from about 10.0 weight percent to about 15.0 weight percent, or from about 15.0 weight percent to about 20.0 weight percent of the emulsifier composition.

A pour point of the emulsifier composition may be less than about 0° C., such as less than about −5° C., less than about −10° C., less than about −15° C., less than about −20° C., or less than about −25° C. Thus, the emulsifier composition may exhibit suitable rheological properties at temperatures as low as about 0° C., such as lower than about −5° C., lower than about −10° C., or lower than about −20° C., facilitating the provision of the emulsifier composition in drilling fluids at a well site (e.g., at the mud pit 116) at conditions to which the mud pit 116 and the well site are exposed.

A viscosity (e.g., a Brookfield viscosity) of the emulsifier composition at about 4.4° C. (about 40° F.) may be within a range of from about 500 centipoise (cP) to about 2,000 cP, such as from about 500 cP to about 750 cP, from about 750 cP to about 1,000 cP, from about 1,000 cP to about 1,250 cP, from about 1,250 cP to about 1,500 cP, from about 1,500 cP to about 1,750 cP, or from about 1,750 cP to about 2,000 cP. The emulsifier composition may exhibit a viscosity less than about 1,500 cP, such as less than about 1,400 cP, less than about 1,300 cP, less than about 1,200 cP, less than about 1,110 cP, less than about 1,000 cP, less than about 900 cP, or even less than about 800 cP at about 4.4° C.

A flash point of the emulsifier composition may be greater than about 76.7° C. (about 170° F.), such as greater than about 80.0° C. (about 176° F.), greater than about 85.0° C. (about 185° F.), greater than about 90.0° C. (about 194° F.), or greater than about 95.0° C. (about 203° F.).

The pour point depressant may facilitate the formation of emulsifier compositions including different ratios of the emulsifier, the wetting agent, and the rheology modifier to achieve desired performance of the emulsifier composition. The emulsifier composition may include from about 0.5 part by weight to about 10.0 parts by weight of the emulsifier for every about 1.0 part by weight of the wetting agent, such as from about 0.5 part to about 1.0 part, from about 1.0 part to about 2.0 parts, from about 2.0 parts to about 5.0 parts, or from about 5.0 parts to about 10.0 parts by weight of the emulsifier for every about 1.0 part by weight of the wetting agent. The emulsifier composition may include from about 0.5 part by weight to about 10.0 parts by weight of the emulsifier for every about 1.0 part by weight of the rheology modifier, such as from about 0.5 part to about 1.0 part, from about 1.0 part to about 2.0 parts, from about 2.0 parts to about 5.0 parts, or from about 5.0 parts to about 10.0 parts by weight of the emulsifier for every about 1.0 part by weight of the rheology modifier.

In some embodiments, the emulsifier composition comprises, consists essentially of, or consists of an amidoamine emulsifier, an alcohol pour point depressant (e.g., 1-octanol, 2-octanol), a wetting agent (e.g., a tall oil-based wetting agent, such as a mixture of oleic acid, linoleic acid, and/or linolenic acid), and a rheology modifier (e.g., dimer acid, trimer acid, a mixture of dimer acid and trimer acid).

In some embodiments, the emulsifier composition comprises, consists essentially of, or consists of the emulsifier and the alcohol pour point depressant. In some embodiments, the emulsifier composition further includes one or both of the wetting agent and the rheology modifier. In some embodiments, the emulsifier composition comprises a flowable composition consisting essentially of or consisting of the emulsifier and the pour point depressant. In some embodiments, the wetting agent composition further includes a base oil (e.g., a solvent) formulated and configured to further reduce the pour point of the wetting agent composition. The base oil, in combination with the pour point inhibitor, may exhibit synergistic properties and may reduce the pour point of the emulsifier composition. The base oil may include diesel oil, mineral oil, a synthetic oil, (e.g., hydrogenated and unhydrogenated olefins including polyalpha olefins, linear and branched olefins, isomerized olefins), a mixture of alkanes with a carbon chain length ranging from C₁₀ to C₂₀, polydiorganosiloxanes, siloxanes, organosiloxanes, or esters of fatty acids, a mixture of C₁₆ to C₁₈ internal olefins.

In some embodiments, the emulsifier composition includes one or more flash point increasers. The flash point increaser may be formulated and configured to increase the flash point of the emulsifier composition and may include one or more base oils or long-chain hydrocarbons (e.g., hydrocarbons including more than 15 carbon atoms). An amount of the flash point increases may be tailored to achieve a desired flash point while maintaining a desired pour point and viscosity of the emulsifier composition.

In some embodiments, a relatively low weight percent of the pour point depressant is sufficient to reduce the pour point of the emulsifier composition to a desired temperature and to maintain suitable rheological properties of the emulsifier composition for providing the emulsifier composition from a drum or barrel to a wellbore fluid. For example, the emulsifier composition may be flowed from a container (e.g., a drum, a barrel) to the mud pit 116 to deliver the emulsifier composition to the wellbore fluid. The pour point depressant facilitates the formation of an emulsifier composition having a relatively low pour point such that the emulsifier composition may be flowed at the well site at temperatures as low as about −25° C. or less and without a solvent or a glycol-based pour point depressant. Since the emulsifier composition does not include a solvent or a glycol-based pour point depressant, and includes a relatively low amount of the pour point depressant, the emulsifier composition may include a higher amount of active ingredients (e.g., the emulsifier) than emulsifier compositions that include and/or require a solvent and/or a glycol-based pour point depressant.

As described above, the wellbore fluid may include one or more additives, which may be selected based on the desired properties of the wellbore fluid. By way of non-limiting example, the one or more additives may include one or more of surfactants, bridging materials, viscosifiers, thinners, weighting materials, filtration control agents, shale stabilizers, pH buffers, scavengers, emulsion activators, gelling agents, shale inhibitors, defoamers, foaming agents, scale inhibitors, solvents, rheological additives, or other additives that may be suitable depending on the particular operation.

The surfactants may include anionic surfactants, cationic surfactants, and/or non-ionic surfactants. The foaming agents may include a nonionic surfactant including polymeric materials. The scale inhibitors may include an acrylic acid polymer, a maleic acid polymer, or a phosphonate. The solvents may include hydrocarbon solvents.

The bridging materials may include one or more of calcium carbonate, magnesium citrate, calcium citrate, calcium succinate, calcium maleate, calcium tartrate, magnesium tartrate, bismuth citrate, other suspended salts, mica, nutshells, fibers, or other building materials. In some embodiments, the building materials comprise calcium carbonate. The bridging material may be functionalized with one or more functional groups, such as one or more hydrophobic functional groups.

Viscosifiers of the drilling fluid may include a material formulated and configured to increase the viscosity of the wellbore fluid and, optionally, to facilitate formation of a filtercake between the earth formation 101 and one or more of (e.g., each of) the drill string 105, casing 107, and liners. The viscosifier may include, for example, organic bentonite clay, an organic polymer (e.g., a cellulosic polymer), a polymer (e.g., a copolymer) formed from at least one acrylamide monomer and at least one sulfonated anionic monomer, or another polymer.

The viscosifier may constitute from about 0.5 weight percent to about 6.0 weight percent of the wellbore fluid, such as from about 0.5 weight percent to about 1.0 weight percent, from about 1.0 weight percent to about 2.0 weight percent, from about 2.0 weight percent to about 3.0 weight percent, or from about 3.0 weight percent to about 6.0 weight percent of the wellbore fluid. However, the disclosure is not so limited, and the weight percent of the viscosifier in the wellbore fluid may be different than that described.

Wellbore fluid thinners may include lignosulfates, lignitic materials, modified lignosulfonates, polyphosphates, tannin, and polyacrylates. The thinners may facilitate improved rheological properties of the wellbore fluid (e.g., a reduction in flow resistance) and a reduction in gel development. In addition, the thinner may reduce a thickness of filtercakes formed by the wellbore fluid, counteract the effects of salts, and reduce the effects of water on the earth formation 101.

Weighting materials (also referred to as “weighting agents”) may include one or more of barite (BaSO₄), iron oxide (e.g., Fe₂O₃, Fe₃O₄), calcium carbonate (CaCO₃), magnesium carbonate (MgCO₃), manganese oxide (Mn₃O₄), or combinations thereof. The weighting material may be present in the wellbore fluid and facilitate increasing the density of the wellbore fluid up to about 2.88 g/cm³ (about 24 pounds per gallon (ppg)).

The pH buffer may include an amine stabilizer, such as one or more of triethanolamine (C₆H₁₅NO₃) (TEOA), methyldiethanolamine (C₅H₁₃NO₂) (MDEA), dimethylethanolamine (C₄H₁₁NO) (DMEA), diethanolamine (C₄H₁₁NO₂) (DEA), monoethanolamine (MEA), cyclic organic amines, sterically hindered amines, amides of fatty acid, or other suitable tertiary, secondary, or primary amines and ammonia. In some embodiments, the pH buffer includes magnesium oxide.

Wetting agents may include one or more alkanolamines, imidazolines, or amidoamines. Filtration control agents may include one or more of uintaite, amine-treated lignite, a polymeric additive, or another material. Shale stabilizers may include organophilic clays, cellulose derivates, or other materials. The scavenger may include, for example, zinc oxide, which may function as a hydrogen sulfide (H₂S) scavenger).

The gelling agent may include one or more of a clay and a crosslinked polyvinylpyrrolidone, an acrylamide copolymer, guar, sodium bentonite, or another material. Defoamers may include one or more of 2-octanol, oleic acid, paraffinic waxes, amide waxes, sulfonated oils, organic phosphates, silicone oils, mineral oils, or dimethylpolysiloxane.

The shale inhibitor may include one or more of amine tartaric salt, ammonium lauric salt, polyammonium, alkyl diammonium, an amphoteric polymer, an organosilicate polymer, a silicone polymer, hexamethylenediamine, bis-hexamethylene triamine, diaminocyclohexane, or another material. In some embodiments, the shale inhibitor includes an amine-based shale inhibitor.

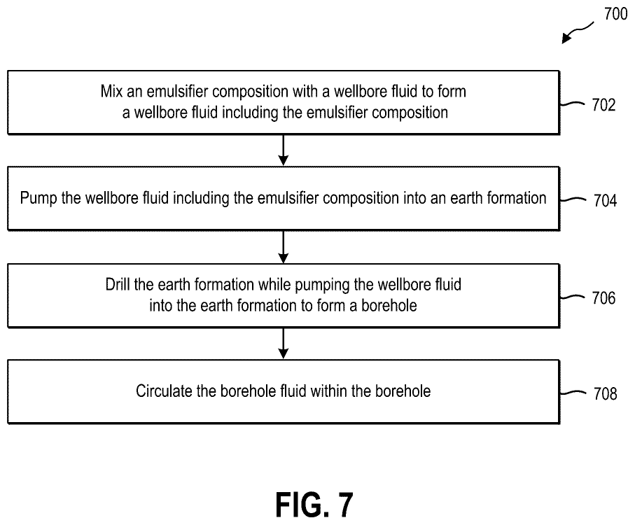

FIG. 7 is a simplified flow diagram illustrating a method of drilling a borehole, according to at least one embodiment of the disclosure. The method 700 includes mixing an emulsifier composition with a wellbore fluid (e.g., a drilling fluid) to form a wellbore fluid including the emulsifier composition, as shown at act 702. In some embodiments, the emulsifier composition is mixed with the wellbore fluid at a mud pit. The wellbore fluid may include one or more of the wellbore fluids described above. For example, the wellbore fluid may include a base fluid, the emulsifier composition, and one or more additives, as described above. In some embodiments, the wellbore fluid comprises a drilling fluid.

The emulsifier composition may include one or more of the emulsifier compositions including one or more of the emulsifiers and one or more of the pour point depressants described above. The emulsifier composition may be substantially free of solvents and glycol-based pour point depressants. In some embodiments, the emulsifier composition includes greater than about 60.0 weight percent, such as greater than about 70.0 weight percent, or greater than about 80.0 weight percent of the emulsifier. In some embodiments, act 702 includes flowing a liquid emulsifier composition into the wellbore fluid, such as from a drum or barrel into a mud pit.

Responsive to forming the wellbore fluid including the emulsifier composition, the method 700 further includes pumping the wellbore fluid including the emulsifier composition into an earth formation, as shown at act 704. With continued reference to FIG. 7, the method 700 may include drilling the earth formation while pumping the wellbore fluid including the emulsifier composition into the earth formation to form a borehole, as shown at act 706. The wellbore fluid may facilitate removal of cuttings from the borehole as the wellbore fluid circulates through the borehole.

The method 700 may further include circulating the wellbore fluid including the emulsifier composition within the borehole, as shown in act 708. For example, the wellbore fluid may be pumped from the surface of the earth formation, through the drill string 105, out of the bit 110, and through the annulus between the drill string 105 and the earth formation 101. In some embodiments, the wellbore fluid is circulated within the borehole while drilling the earth formation. In some embodiments, the emulsifier facilitates the formation of a stable emulsion in the drilling fluid while drilling the borehole.

Accordingly, the alcohol pour point depressant in the emulsifier composition facilitates proving the emulsifier composition including a higher weight percent of active components to the wellbore fluid from a drum or barrel, even at low temperatures that may be encountered at a well site. A lower amount of the pour point depressant in the emulsifier package may reduce the pour point of the emulsifier composition and may also be less costly to manufacture. In other instances, the emulsifier composition may include a comparable amount of the pour point depressant as emulsifier compositions including glycol-based pour point depressants, but may exhibit a relatively lower viscosity, facilitating the ease of use (e.g., pourability) of the emulsifier composition including the alcohol-based pour point depressant. In addition, once in the wellbore fluid (e.g., the drilling fluid), the emulsifier composition may not include glycol-based additives that may be detrimental to the wellbore fluid, such as by negatively affecting the emulsion stability in invert emulsions due to an improper HLB valve. In addition, glycol-based pour point depressants may be susceptible to reaction with the emulsifier when exposed to elevated temperatures for long durations, as may be encountered during drilling operations. In addition, too high a concentration of glycols in drilling fluids may cause mud motor (mud pump) elastomers to fail. Reducing the concentration of glycols in the drilling fluids may reduce a wear and tear on such downhole equipment. Other pour point depressants, such as esters, may undergo hydrolysis and release small volatile compounds that may increase the pour point of the wellbore fluid. The pour point depressants described herein may not undergo hydrolysis reactions and may be stable at elevated wellbore temperatures and may not form materials that negatively affect the performance of the emulsifier in the wellbore fluid.

### EXAMPLES

### Example 1

The performance of various pour point depressants in drilling fluids were tested by mixing emulsifier compositions including different pour point depressants with a drilling fluid composition. The drilling fluid composition is shown in Table 1 below.

TABLE 1

| Material | Mass (pounds per barrel) (ppb) |
|---|---|
| Base oil | 138 |
| Emulsifier composition (excluding | 8.54 |
| pour point depressant) | |
| Pour point depressant | 3.00 |
| Wetting agent | 1.60 |
| Rheology additive (organoclay) | 0.50 |
| Lime | 3.00 |
| 25% CaCl₂ brine | 77.7 |
| Suspending clay | 8.0 |
| Synthetic fluid loss additive | 1.00 |
| Rheology modifier | 2.13 |
| Barite | 356 |

In Table 1, the drilling fluid exhibited a density of about 14.3 pounds per gallon (ppg) and an oil to water ratio of about 77/23 (e.g., the drilling fluid included 77 parts by volume of the oleaginous material (the base oil) and about 23 parts by volume water after retort distillation (and collecting all non-aqueous volatile species and water, but not salts).

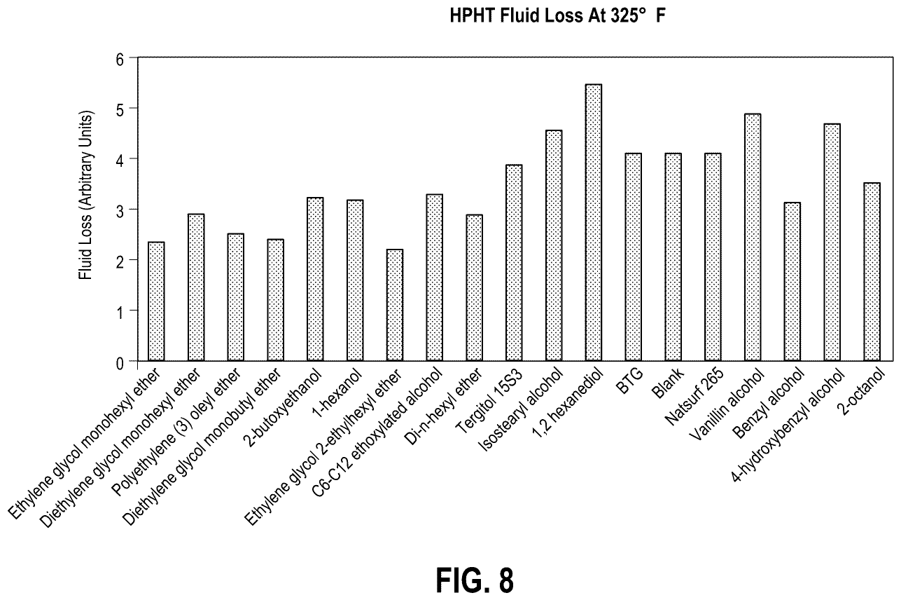

The emulsifier composition used in each drilling fluid includes a different pour point depressant. FIG. 8 is a graph illustrating the fluid loss after hot rolling (at about 162.8° C. (about 325° F.) for about 16 hours). In the fluid loss test, the drilling fluids were exposed to HPHT testing at a differential pressure of about 500 psi (about 3.45 MPa) after 60 minutes using a WFAO-A disk for filtration under an API HPHT fluid-loss test.

In FIG. 8, the polyoxyethylene (3) oleyl ether was commercially available from Croda International Plc of the Yorkshire, United Kingdom; the C₆-C₁₂ ethoxylated alcohol was Novel® 810-2 commercially available from Sasol of Johannesburg, South Africa; the Tergitol™ 15-S-3 Surfactant included a secondary alcohol ethoxylate commercially available from Sasol of Johannesburg, South Africa; the Natsurf™ 265 was a non-ionic alcohol ethoxylate based on a primary alcohol and commercially available from Croda International Plc of the Yorkshire, United Kingdom. The sample labeled “blank” in FIG. 8 did not include any pour point depressant and the emulsifier composition included only the emulsifier dissolved in base oil.

The fluid loss may be an indication of emulsion stability of the drilling fluid. A higher fluid loss indicates less emulsion stability. With reference to FIG. 8, many of the tested pour point depressants exhibited less fluid loss than the BTG. The drilling fluids that exhibited a higher fluid loss than the drilling fluid including the BTG included 1-2-hexanodiol, the isostearyl alcohol, Natsurf™ 265, vanillin alcohol, and the 4-hydroxybenzyl alcohol. It is believed that the 1-2-hexanodiol exhibited a relatively higher fluid loss due to the two hydroxyl groups of the 1-2-hexanodiol; the isostearyl alcohol exhibited a relatively higher fluid loss due to the relatively longer chain length of the alcohol (C₁₈); the Natsurf™ 265 exhibited a relatively higher fluid loss due to the higher amount of carbons in the alcohol ethoxylate; and each of the vanillin alcohol and the 4-hydroxylbenzyl alcohol exhibited relatively higher fluid loss due to the presence of two hydroxyls group in each. With reference to FIG. 8, the drilling fluids including emulsifier compositions including pour point depressants having a relatively lower molecular weight and/or a single hydroxyl group exhibited less fluid loss (and better emulsion stability) than the other drilling fluids.

The viscosity of different emulsifier compositions including different pour point depressants was measured at about 4.44° C. (about 40.0° F.). The viscosity of each emulsifier composition was measured using a Brookfield viscometer. Table 2 shows the viscosity of each of the emulsifier compositions.

TABLE 2

| | Brookfield viscosity at 40° F. |
|---|---|
| Pour Point Depressant | (centipoise) |
| Triethylene glycol monobutyl ether (BTG) | 1880 |
| Diethylene glycol monohexyl ether | 1508 |
| Ethylene glycol monohexyl ether | 1100 |
| 1-hexanol | 776 |
| 2,3-methyl-1-hexyn-3-ol | 1464 |
| 2-methyl-3-butene-1-ol | 697 |
| C₆-C₁₂ ethoxylated alcohol | 1992 |
| 1-octanol | 1057 |
| 2-octanol | 861 |
| Isalchem 125A | 1764 |
| 1-decanol | 1502 |
| 2-butyl-1-octanol | 1484 |
| Isotridecanol | 1834 |

In Table 2, the Isalchem® 125A was an isomeric primary alcohol commercially available from Sasol of Johannesburg, South Africa. With reference to Table 2, lower molecular weight alcohols, such as 2-methyl-3-butene-1-ol exhibited the lowest viscosity. Ethoxylation of the lower molecular weight alcohols may facilitate increasing the flash point of such low molecular weight alcohols. The flash point and the effectiveness of the pour point depressant at lowering the pour point of the emulsifier composition may be balanced. Interestingly, even C₁₃ isotridecanol, which is not ethoxylated, exhibited a lower viscosity than the BTG.

The embodiments of wellbore (e.g., drilling) fluids including the emulsifier composition including the pour point depressant have been primarily described with reference to wellbore drilling operations; the wellbore fluids described herein may be used in applications other than the drilling of a wellbore or borehole. In other embodiments, wellbore fluids including the emulsifier composition according to the present disclosure may be used outside a wellbore, borehole, or other downhole environment used for the exploration or production of natural resources. Accordingly, the terms “wellbore,” “borehole,” and the like should not be interpreted to limit tools, systems, assemblies, or methods of the present disclosure to any particular industry, field, or environment. In addition, the drilling fluids may be used in cased completion wellbores and in open hole completion wellbores.

In some embodiments, the wellbore fluids may be used during formation of a wellbore to be used for carbon capture, utilization, and storage (CCUS) and/or for recovery and use of geothermal energy. CCUS facilitates the capture, use, and/or storage of carbon (e.g., carbon dioxide), which has a goal of achieving carbon neutrality and/or net zero carbon emissions (NZE). CCUS may facilitate the capture of carbon dioxide from large point sources (e.g., power plants, refineries, cement plants, other industrial processing plants, or other industrial facilities that use fossil fuels, biomass fuels, or other fuels that generate carbon dioxide). The captured carbon dioxide may be converted into valuable products such as, for example, ethanol, sustainable aviation fuel, chemicals, and mineral aggregates. Alternatively, the carbon dioxide may be stored in geologic formations, such as in depleted hydrocarbon reservoirs. The carbon dioxide may be introduced into the earth formation through a wellbore formed using the wellbore fluids described herein. In the earth formation, the carbon dioxide may be dispersed in an aqueous phase and stored as carbon dioxide, in mineral form (e.g., as a carbonate, such as calcium carbonate, magnesium carbonate, iron(II) carbonate), or as another form of carbon.

Geothermal energy is a promising source of renewable energy that captures energy from heat generated within the earth. For example, geothermal energy may be used to heat structures (e.g., buildings) and/or to generate electricity (e.g., by heating water to generate steam and drive a turbine with the steam). The wellbore fluids described herein may be used to form wellbores used to circulate a fluid that is heated within the earth formation through which the wellbore extends. The heated fluid may be circulated to the surface where the captured heat may be recovered to heat a structure and/or generate electricity, followed by recirculation of the fluid to the earth formation to continue the cycle.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. An emulsifier composition for a wellbore fluid, the emulsifier composition comprising:
an emulsifier including an amidoamine; and
a pour point depressant including one or both of a C₅ to C₁₃ or a C₅ to C₁₂ alkoxylated alcohol including two or fewer alkylene oxide groups,
wherein the emulsifier composition exhibits a viscosity less than about 1,500 cP at about 4° C.

2. The emulsifier composition of claim 1, wherein the pour point depressant includes one or more C₆ to C₁₃ linear alcohols.

3. The emulsifier composition of claim 1, wherein the pour point depressant includes one or more of octanol, nonanol, decanol, or undecanol.

4. The emulsifier composition of claim 1, wherein the pour point depressant includes 1-octanol, 2-octanol, or a combination thereof.

5. The emulsifier composition of claim 1, wherein the pour point depressant includes 2-octanol.

6. The emulsifier composition of claim 1, wherein the emulsifier composition exhibits pour point less than about 0° C.

7. The emulsifier composition of claim 1, wherein the pour point depressant includes more than one type of alcohol.

8. The emulsifier composition of claim 1, wherein a molecular weight of the pour point depressant is less than 150 g/mol.

9. The emulsifier composition of claim 1, wherein the pour point depressant includes a C₅ to C₁₀ ethoxylated alcohol.

10. The emulsifier composition of claim 1, wherein the pour point depressant constitutes less than about 20.0 weight percent of the emulsifier composition.

11. The emulsifier composition of claim 1, wherein the amidoamine includes a reaction product of an amide and one or more dicarboxylic acids.

12. The emulsifier composition of claim 11, wherein the amide includes a reaction product of diethylenetriamine and one or more fatty acids.

13. The emulsifier composition of claim 1, wherein the amidoamine includes a reaction product of an amide and maleic acid or maleic anhydride.

14. The emulsifier composition of claim 1, further comprising at least one of a wetting agent or a rheology modifier.

15. The emulsifier composition of claim 1, further comprising a wetting agent including one or more fatty acids.

16. The emulsifier composition of claim 1, further comprising a rheology modifier including a C₃₆ dimer, a C₅₄ dimer, or both.

17. A method of forming a borehole extending through an earth formation, the method comprising:
mixing an emulsifier composition with a drilling fluid, the emulsifier composition exhibiting a pour point lower than about 0° C., the emulsifier composition including:
an emulsifier including an amidoamine; and
a pour point depressant including an alcohol having fewer than thirteen carbon atoms and less than two ethylene oxide groups; and
forming a borehole in the earth formation while pumping the drilling fluid including the emulsifier composition into the earth formation.

18. The method of claim 17, wherein mixing an emulsifier composition with a drilling fluid includes mixing an emulsifier composition including greater than about 60.0 weight percent of the amidoamine with the drilling fluid.

19. The method of claim 17, wherein mixing emulsifier composition with a drilling fluid includes flowing the emulsifier composition from a drum or barrel into a mud pit to mix the emulsifier composition with the drilling fluid.

20. A wellbore fluid, comprising:
an oleaginous base fluid; and
an emulsifier composition comprising:
an emulsifier including an amidoamine comprising a reaction product of a bis-amide and one or more of maleic acid, maleic anhydride, fumaric acid, succinic acid, succinic anhydride, oxalic acid, malonic acid, adipic acid, azelaic acid, muconic acid, citraconic acid, itaconic acid, tartaric acid, or glutaric acid;
a pour point depressant including a C₅ to C₁₃ alcohol including fewer than one ethylene oxide group, the emulsifier composition exhibiting a pour point lower than about 0° C.; and
at least one of a wetting agent and a rheology modifier.
